(19) United States
(12) Patent Application Publication
(10) Pub. No.: US 2004/0092192 A1
(43) Pub. Date: May 13, 2004

(54) Hollow fiber nonwoven sheet for fabric softener substrate

(75) Inventor: Edward Keith Willis, Madison, TN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Reemay, Inc.

(21) Appl. No.: 10/289,674

(22) Filed: Nov. 7, 2002

(51) Int. Cl. B32B 27/02; B32B 27/04; B32B 27/12; D04H 1/00; D04H 3/00; D04H 5/00; D04H 13/00; D04H 1/06; D04H 1/74; D04H 3/05; D04H 3/16

(52) U.S. Cl. 442/401; 442/327; 442/335; 442/338; 442/359; 442/366; 428/299.7; 428/300.4

(57) ABSTRACT

The present invention provides a nonwoven fabric that is especially engineered to function as the substrate for a dryer activated fabric softener sheet. The substrate has a basis weight of 0.48 ounces per square yard or less, a thickness of from about 0.16 mm to about 0.38 mm, and comprises a nonwoven web of fibers, wherein at least some of the fibers are hollow. Preferably the fibers have a denier of from 2 to 8. In preferred embodiments of the invention, the hollow fibers have a void area at least 10 percent of the fiber cross-section, and the fibers have a noncircular trilobal cross-section.

### FIELD OF THE INVENTION

The present invention relates to dryer activated fabric conditioning products, and in particular to an improved substrate for a dryer activated fabric softener product.

### BACKGROUND OF THE INVENTION

The dryer activated fabric softener sheets that are commercially available today use a nonwoven fabric substrate, usually made of polyester fibers, that has been coated with a fabric softener composition. Both the fabric softener composition and the nonwoven fabric substrate are carefully engineered so that the fabric softener composition will be transferred to clothing articles in a uniform and controlled manner during a standard drying cycle of an automatic clothes dryer. The substrate, in particular, must be capable of holding a sufficient amount of the fabric softener composition to achieve the desired conditioning of the fabric, and to release this fabric softener composition gradually during the drying cycle so that the composition is applied uniformly to the various clothing articles in the clothes dryer. The substrate is also designed to have a desired level of softness, as well as other aesthetic properties, when user separates the exhausted fabric softener sheet from the clothing after completion of the drying cycle. Childs et al. U.S. Pat. Nos. 5,470,492; 5,883,069; 5,929,026; and 6,357,137 describe the evolution of nonwoven fabric substrates for dryer activated fabric softener products as improvements have been made to the substrate. As seen from these patents, various fabric physical properties, such as thickness, fabric basis weight and fiber denier, are carefully controlled within prescribed ranges to achieve the required performance of the fabric as a dryer sheet substrate.

### SUMMARY OF THE INVENTION

The present invention provides further improvements in the substrate for a dryer activated fabric softener product. In particular, the present invention maintains the critically important performance characteristics of the substrate, such as coating capacity and release properties, while reducing the basis weight of the substrate. The present invention is based upon the recognition that the interior or core portion of the fibers from which the nonwoven fabric is made does not contribute materially to the performance of the nonwoven fabric as a dryer sheet substrate. By eliminating the core of the fiber, i.e. by making the fiber hollow, it is possible to significantly reduce the overall basis weight of the fabric substrate and the attendant material cost. Surprisingly, fabric strength, as well as the critical performance properties as a dryer sheet substrate, are maintained.

The substrate according to the present invention has a basis weight of 0.48 ounces per square yard or less, a thickness of from about 0.16 mm to about 0.38 mm, and comprises a nonwoven web of fibers, wherein at least some of the fibers are hollow. Preferably the fibers have a denier of from 2 to 8. In preferred embodiments of the invention, the hollow fibers have a void area at least 10 percent of the fiber cross-section, and the fibers have a noncircular cross-section.

According to one specific embodiment of the present invention, the substrate has a basis weight of 0.48 ounces per square yard or less, a thickness of from about 0.16 mm to about 0.38 mm, and comprises a nonwoven spunbonded web of continuous polyester filaments, at least 25 percent of said filaments having a noncircular cross-section and being hollow.

In a further specific embodiment, the substrate has a basis weight of 0.48 ounces per square yard or less, a thickness of from about 0.16 mm to about 0.38 mm, and comprises a nonwoven spunbonded web of continuous filaments, including hollow matrix filaments of a trilobal cross-section formed from a polyester homopolymer and binder filaments formed from a polyester copolymer, and wherein said hollow matrix filaments have a denier of from 2 to 8.

In another specific embodiment, the present invention provides a substrate for a dryer activated fabric softener product, in which the substrate has a basis weight of 0.48 ounces per square yard or less, a thickness of from about 0.16 mm to about 0.38 mm, and comprises a nonwoven spunbonded web of continuous hollow matrix filaments of a trilobal cross-section formed from a polyester homopolymer. The hollow matrix filaments have a void area at least 10 percent of the fiber cross-section and a denier of from 2 to 8. The spunbonded web also comprises binder filaments of a solid cross-section formed from a polyester copolymer. The binder filaments serve to bond the matrix filaments and form a web having tensile and tear strength sufficient for use as a substrate for a dryer activated fabric softener product.

### BRIEF DESCRIPTION OF THE DRAWING

Some of the features and advantages of the invention having been described, others will become apparent from the detailed description which follows, and from the accompanying drawing, in which—

FIG. 1 is a schematic illustration of an arrangement of apparatus for producing the nonwoven substrate of the present invention.

FIGS. 2 and 3 are photomicrographs of cross-sections of nonwoven substrates in accordance with the present invention, in which the filaments cross-sections can be seen.

### DETAILED DESCRIPTION OF THE INVENTION

The present inventions now will be described more fully with reference to the accompanying drawings, in which some, but not all embodiments of the invention are shown. Indeed, the present invention may be embodied in many different forms and should not be construed as being limited to the specific illustrative embodiments set forth herein; rather, these embodiments are provided so that this disclosure will satisfy applicable legal requirements. Like numbers refer to like elements throughout.

The substrate fabrics of the present invention are suitably manufactured by various manufacturing processes well-known in the nonwovens industry, and can be produced either from discrete length staple fibers or from continuous filamentary fibers. Unless the context dictates otherwise, the term “fiber” is used herein in a generic sense to include both staple fibers and continuous filaments. In the specific embodiments of the invention described herein, the nonwoven fabric is a spunbond nonwoven manufactured generally in accordance with the process described in U.S. Pat. No. 3,989,788. Continuous filaments of molten thermoplastic polymer are extruded from spinneret orifices, quenched and drawn, and then are randomly deposited onto an advancing air permeable conveyor belt to form an unbonded web of filaments. The filaments are then bonded to one another by application of heat to form a strong coherent nonwoven fabric. In the spinning apparatus, one or more (typically four or five) spin beams are successively arranged in the machine direction, each extending transversely across the conveyor belt. Each spin beam is fed with molten thermoplastic polymer from an extruder, and is equipped with spinneret plates across the machine direction for extruding a curtain of filaments across the width of the conveyor belt.

In accordance with the present invention, at least one of the spin beams is equipped with spinnerets configured for forming hollow filaments. Spinnerets of this type are commercially available from various sources, such as Ceccato Spinnerets of Milan, Italy. Preferably, the spinneret configuration, and the spinning conditions are selected to provide a void area in the hollow filaments of at least 10 percent of the filament cross-section. Also preferably, the hollow filaments have a noncircular cross-section, most preferably a trilobal cross sectional configuration. Especially preferred are hollow trilobal cross-section filaments with a void area of at least 10 percent, more preferably about 15 percent.

In one embodiment of the invention, one of four spin beams is equipped with spinnerets configured for forming hollow matrix filaments, and the remaining three spin beams are equipped with spinnerets for spinning solid cross-section matrix filaments. Using spinnerets with equal numbers of orifices, this results in a nonwoven fabric containing 25 percent hollow filaments and 75 percent solid cross-section filaments. In other embodiments of the invention, a higher percentage of hollow matrix filaments can be provided in the fabric, and in one particularly preferred embodiment all of the matrix filaments are hollow.

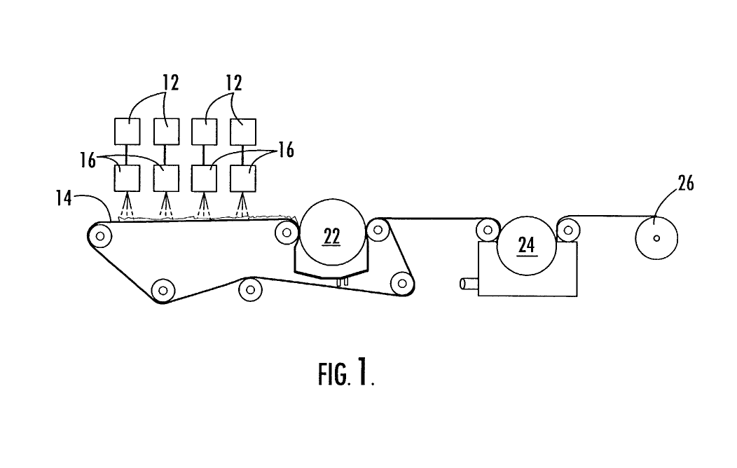

FIG. 1 schematically illustrates an arrangement of apparatus for producing a polyester nonwoven web suitable for use as a substrate for a dryer activated fabric softener product in accordance with the present invention. A web of continuous filaments is produced, including both homopolymer filaments of polyethylene terephthalate, and copolymer filaments of 70 to 90% by weight ethylene terephthalate repeating units and 10 to 30% by weight of other ester repeating units. The homopolymer filaments constitutes the matrix filaments while the copolymer filaments have a lower melting point and are referred to as binder filaments. The percentages by weight of binder filaments is between about 5 and 30, the remainder being matrix filaments. The copolyester binder filaments are preferably polyethylene terephthalate/isophthalate copolymer filaments.

The apparatus includes four spin beams 12 mounted above an endless moving conveyor belt 14. Each beam extends widthwise in the cross-machine direction, and the respective beams are successively arranged in the machine direction. Each beam is supplied with molten polyester homopolymer and with molten polyester copolymer from respective extruders (not shown). Spinnerets configured for producing hollow trilobal matrix filaments are mounted to each of the four spin beams 12. The molten polyester homopolymer is extruded from the spinneret orifices in the form of a curtain of fine hollow filaments of trilobal cross-section. Spinnerets for producing binder fibers are also provided on the spin beams 12. These spinnerets receive molten polyester copolymer and extrude this polymer in the form of fine continuous filaments, which can be of a generally circular solid cross-section.

The freshly extruded filaments are cooled and solidified by contact with a flow of quench air, and the filaments are then attenuated and drawn, either mechanically or pneumatically by attenuator devices 16. The filaments are then deposited randomly onto the advancing belt 14 to form a web. This web of unbonded filaments is then directed through a steam consolidator 22, where the web is contacted with saturated steam which serves to soften the binder filaments. The pressure which is applied in this step between the collecting belt and the hard roll is just sufficient to stabilize the web and minimize shrinkage, without substantially compressing or reducing the thickness of the web.

The web is then transferred to a hot air bonder 24. The temperatures used in the bonding operation are considerably higher than those used in consolidation, the temperature selected being dependent upon the properties desired in the product (i.e., strength, dimensional stability or stiffness). Typically the consolidated web is exposed to air at 140 to 250 degrees C. preferably 215 to 250 degrees C. during bonding.

The hot air bonding that takes place following steam consolidation provides the necessary sheet properties such as tear strength and tensile strength. In the hot air zone the matrix and binder fibers bond to one another. The binder filaments soften, melt, or flow. The matrix filaments soften only slightly. In this operation the matrix filaments are set in the desired configuration. The binder fibers lose much of their filamentary form and act as an adhesive for the hollow matrix filaments, which retain their form. Bonded web passes over exit roll to a windup device 26.

The thus manufactured nonwoven fabric substrate may be coated with a suitable dryer activated softener composition using various coating methods that are well known in the art. Examples of dryer activated softener compositions are described in U.S. Pat. Nos. 5,804,547; 6,107,270; 6,133,226 and 6,169,067.

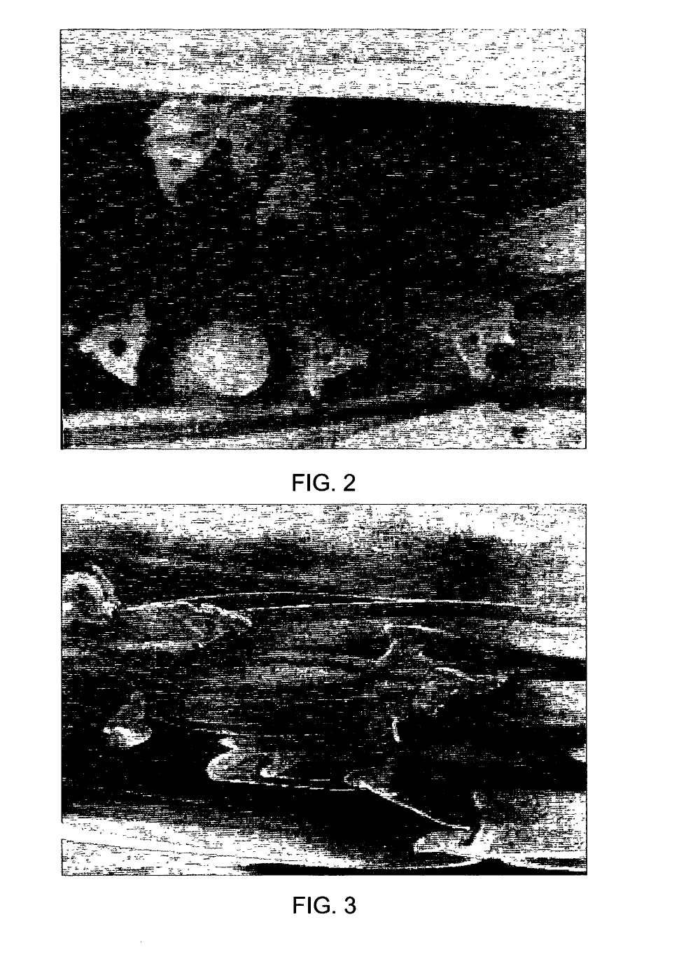

FIG. 2 is a photomicrograph showing a cross-section of a nonwoven fabric substrate in accordance with the present invention. The hollow trilobal matrix filaments and a solid round cross-section binder filament can be seen. FIG. 3 is a photomicrograph of another nonwoven fabric substrate in accordance with the present invention, in which the hollow trilobal matrix filaments are visible. Because the binder filaments represent only a small percentage of the filaments, they are not visible in this specimen.

In another embodiment of the invention, the copolyester binder polymer can be combined with the polyester homopolymer matrix polymer in the same filaments, rather than having separate binder filaments and matrix filaments. Preferably, this is achieved by forming hollow trilobal filaments with the polyester homopolymer matrix polymer composition located in the central portions of the hollow trilobal filament cross-section, and with the copolyester binder polymer located at the tips of the lobes of the filaments.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A substrate for a dryer activated fabric softener product, said substrate having a basis weight of 0.48 ounces per square yard or less, a thickness of from about 0.16 mm to about 0.38 mm, and comprising a nonwoven web of fibers, at least some of said fibers being hollow.

2. The substrate of claim 1, wherein said hollow fibers have a denier of from 2 to 8.

3. The substrate of claim 1, wherein said hollow fibers have a void area at least 10 percent of the fiber cross-section.

4. The substrate of claim 1, wherein said hollow fibers have a noncircular cross-section.

5. The substrate of claim 1, wherein said fibers comprise randomly arranged continuous spunbonded filaments.

6. The substrate of claim 5, wherein said filaments include hollow filaments and filaments of a solid cross-section.

7. The substrate of claim 6, wherein at least 25 percent of said filaments are hollow filaments.

8. A substrate for a dryer activated fabric softener product, said substrate having a basis weight of 0.48 ounces per square yard or less, a thickness of from about 0.16 mm to about 0.38 mm, and comprising a nonwoven spunbonded web of continuous polyester filaments, at least 25 percent of said filaments having a noncircular cross-section and being hollow.

9. The substrate of claim 8, wherein said hollow filaments have a void area at least 10 percent of the filament cross-section.

10. The substrate of claim 9, wherein said hollow filaments have a trilobal cross-section.

11. The substrate of claim 8, wherein said fabric includes hollow filaments of a trilobal cross-section formed from a polyester homopolymer, and said fabric additionally includes binder filaments formed of a polyester copolymer, said binder filaments forming bonds throughout the fabric.

12. A substrate for a dryer activated fabric softener product, said substrate having a basis weight of 0.48 ounces per square yard or less, a thickness of from about 0.16 mm to about 0.38 mm, and comprising a nonwoven spunbonded web of continuous filaments, including hollow matrix filaments of a trilobal cross-section formed from a polyester homopolymer and binder filaments formed from a polyester copolymer, and wherein said hollow matrix filaments have a denier of from 2 to 8.

13. The substrate of claim 12, wherein said hollow filaments have a void area at least 10 percent of the filament cross-section.

14. The substrate of claim 12, wherein the continuous filaments constituting said substrate include filaments of at least two different deniers.

15. A substrate for a dryer activated fabric softener product, said substrate having a basis weight of 0.48 ounces per square yard or less, a thickness of from about 0.16 mm to about 0.38 mm, and comprising a nonwoven spunbonded web of continuous hollow matrix filaments of a trilobal cross-section formed from a polyester homopolymer, said hollow matrix filaments having a void area at least 10 percent of the fiber cross-section and a denier of from 2 to 8, and said spunbonded web also comprising binder filaments of a solid cross-section formed from a polyester copolymer, the binder filaments serving to bond the matrix filaments and form a web having tensile and tear strength sufficient for use as a substrate for a dryer activated fabric softener product.

16. A method for producing a substrate for a dryer activated fabric softener product, said method comprising:
extruding molten polyester homopolymer from spinnerets to produce hollow matrix fibers of a denier of from 2 to 8;
extruding molten polyester copolymer from spinnerets to produce binder fibers;
depositing the matrix fibers and binder fibers on a collection surface to form a nonwoven web; and
bonding the fibers together to form a coherent bonded nonwoven web having a thickness of from about 0.16 mm to about 0.38 mm and a basis weight of 0.48 ounces per square yard or less.

17. The method of claim 16, wherein step of extruding molten polyester homopolymer to produce hollow fibers includes forming the fibers with a void area at least 10 percent of the fiber cross-section.

18. A method for producing a substrate for a dryer activated fabric softener product, said method comprising:
extruding molten polyester homopolymer from spinnerets to produce hollow matrix filaments of a trilobal cross-section and a denier of from 2 to 8;
extruding molten polyester copolymer from spinnerets to produce binder filaments;
depositing the matrix filaments and binder filaments on a collection surface to form a nonwoven web; and
bonding the filaments together to form a coherent bonded nonwoven web having a thickness of from about 0.16 mm to about 0.38 mm and a basis weight of 0.48 ounces per square yard or less.

19. The method of claim 18, wherein step of extruding molten polyester homopolymer to produce hollow filaments includes forming the filaments with a void area at least 10 percent of the filament cross-section.

20. The method of claim 19, wherein the step of extruding molten polyester copolymer to produce binder filaments includes forming the binder filaments in a solid circular cross-section.
